(19) United States
(12) Patent Application Publication
(10) Pub. No.: US 2016/0303844 A1
(43) Pub. Date: Oct. 20, 2016

(54) DOUBLE-SIDED IMPRINTING WITH A BACK ROLLER

(71) Applicant: Eastman Kodak Company, Rochester, NY (US)

(72) Inventors: John Andrew Lebens, Rush, NY (US); Yongcai Wang, Rochester, NY (US); Ronald Steven Cok, Rochester, NY (US); Mitchell Lawrence Wright, Rochester, NY (US)

(21) Appl. No.: 14/687,145

(22) Filed: Apr. 15, 2015

(51) Int. Cl. B41F 7/20

(52) U.S. Cl. CPC B41F 7/20

(57) ABSTRACT

A method of making an imprinted double-sided structure includes providing a substrate having first and second opposing sides, first and second imprinting stamps each having an imprinting side and a support side with first and second portions, and first and second rollers. A curable layer is formed on each side of the substrate. The imprinting side of each stamp is located facing the corresponding substrate side and each roller is located facing the corresponding first portion of the support side of each imprinting stamp. Simultaneously, the rollers are pressed against the respective first portions and rolled along the respective support surfaces of the first and second stamps from the first portion to the second portion. The first and second curable layers are simultaneously cured to form cured imprinted layers on both sides of the substrate. The first and second stamps are removed.

### FIELD OF THE INVENTION

The present invention relates to methods and apparatus for imprinting a curable layer coated on a substrate.

### BACKGROUND OF THE INVENTION

Imprint lithography is a method of forming three-dimensional structures on a substrate. The three-dimensional structures can provide high-resolution patterns, large manufacturing throughput, low cost, and potentially large area coverage. In imprint lithography, a mold with a pattern of projecting and recessed features is pressed into a moldable surface, typically a thin film, deforming the shape of the film and forming a relief pattern in the film. The film is hardened, for example with ultra-violet or thermal curing, and the mold and imprinted substrate are separated. After the mold is removed, the underlying substrate is available for further processing. Imprint lithography can be used to replicate patterns having high-resolution features in the micro-scale and nano-scale ranges. For example, U.S. Pat. No. 5,772,905 issued Jun. 30, 1998 and entitled “Nanoimprint Lithography” describes high-resolution imprint methods and is incorporated herein by reference.

Flexing of the mold and the substrate during the mechanical imprinting step is a technical limitation on the resolution of structures manufactured using imprint lithography. There is a need, therefore, for improved equipment and an improved method for high-resolution imprint lithography.

### SUMMARY OF THE INVENTION

In accordance with an embodiment of the present invention, a method for making an imprinted double-sided structure comprises:

providing a substrate having first and second substantially planar and parallel opposing sides;

providing a first imprinting stamp having a substantially flat support side and an opposed imprinting side, the support side having a first portion and a second portion;

providing a second imprinting stamp having a substantially flat support side and an opposed imprinting side, the support side having a first portion and a second portion;

providing a first roller having a surface and a first-roller axis about which the first roller surface rotates;

providing a second roller having a surface and a second-roller axis about which the second roller surface rotates;

forming a first curable layer on the first side of the substrate and a second curable layer on the second side of the substrate;

locating the imprinting side of the first imprinting stamp facing the first side of the substrate;

locating the imprinting side of the second imprinting stamp facing the second side of the substrate;

locating the first roller facing the first portion of the support side of the first imprinting stamp;

locating the second roller facing the first portion of the support side of the second imprinting stamp;

simultaneously pressing the first roller against the first portion of the first imprinting stamp and pressing the second roller against the first portion of the second imprinting stamp, the first-roller axis located substantially parallel to the first side, the second-roller axis located substantially parallel to the second side, and a line intersecting the first-roller axis, the second-roller axis, and the substrate substantially perpendicular to the first and second sides of the substrate;

simultaneously rotating the first roller about the first-roller axis rotating the second roller about the second-roller axis and simultaneously rolling the surface of the first roller over and in contact with the surface of the support side of the first imprinting stamp from the first portion to the second portion of the first imprinting stamp and rolling the surface of the second roller over and in contact with the surface of the support side of the second imprinting stamp from the first portion to the second portion of the second imprinting stamp;

simultaneously curing the first curable layer to form a first cured imprinted layer on the first side of the substrate and curing the second curable layer to form a second cured imprinted layer on the second side of the substrate;

removing the first imprinting stamp from the first side and removing the second imprinting stamp from the second side.

Advantages of the present invention include a method and equipment for imprinting a curable layer coated on a substrate with improved resolution and accuracy.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIGS. 1-8 are sequential cross sections of stamps, rollers, and a substrate useful in understanding embodiments of the present invention; and

FIGS. 9-13 are flow charts illustrating various methods of making the present invention.

The Figures are not necessarily to scale, since the range of dimensions in the drawings is too great to permit depiction to scale.

### DETAILED DESCRIPTION OF THE INVENTION

The present invention is directed toward making an imprinted structure on each side of a substrate by simultaneously pressing rollers against support sides of stamps imprinting a curable layer formed on each side of the substrate. The invention provides a method and equipment for imprinting a curable layer coated on a substrate with improved resolution and accuracy. In useful embodiments, both the stamp and the substrate are flexible and the method reduces substrate and stamp flexing and the amount of air trapped in the curable layer, thereby improving the accuracy and resolution of the imprinted structure.

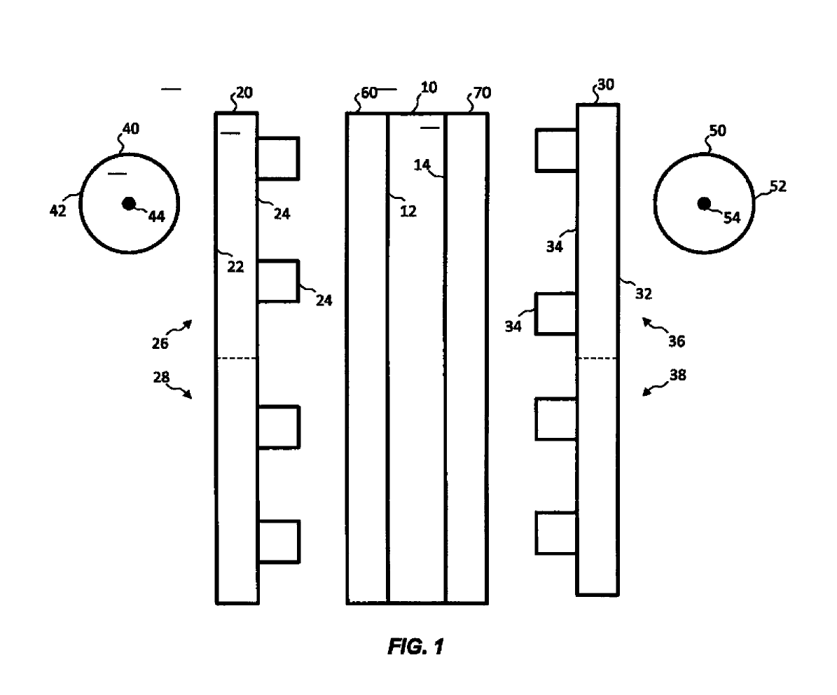

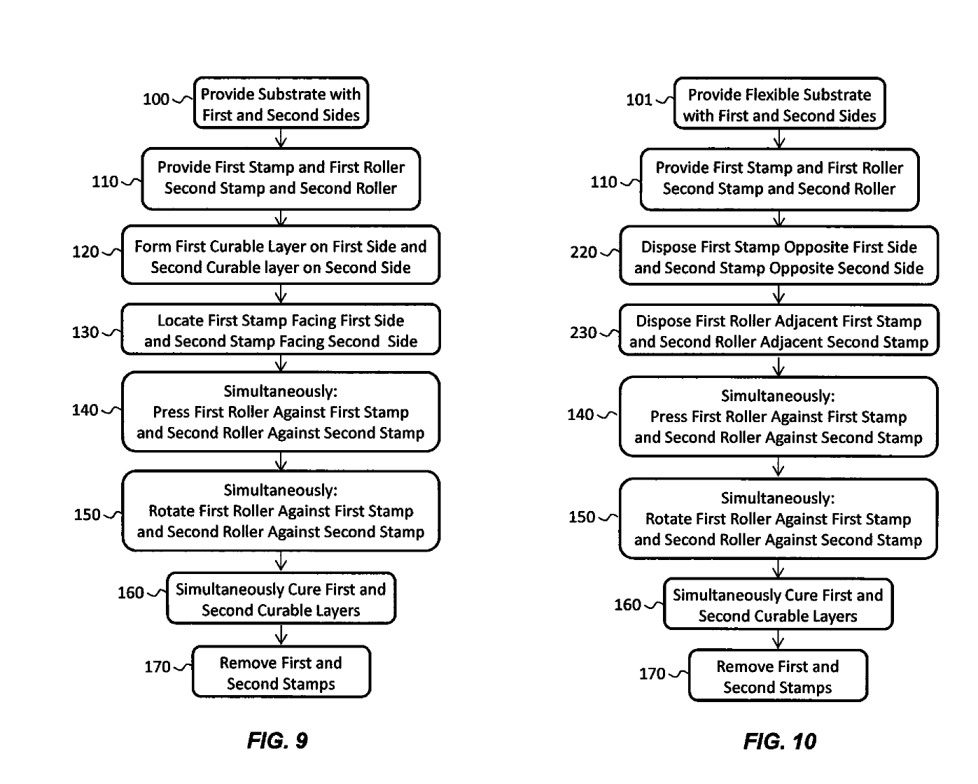

Referring to the structure and equipment illustrated in FIG. 1 and the method illustrated in FIG. 9, in an embodiment of the present invention a substrate 10 is provided in step 100. The substrate 10 includes a first side 12 and an opposed second side 14. The first side 12 and the second side 14 of the substrate 10 are substantially planar and parallel. In an embodiment, the substrate 10 is flexible. In an alternative embodiment, the substrate 10 is rigid. Suitable materials, for example glass, metal, or ceramic useful for rigid substrates are known, as are materials suitable for flexible substrates, such as polymer, plastics, or thin metals. Manufacturing methods for making substrates 10 with smooth, planar, and substantially parallel opposing sides are also well known.

First and second imprinting stamps 20, 30 and first and second rollers 40, 50 are provided in step 110. The first imprinting stamp 20 has a substantially flat support side 22 and an opposed imprinting side 24. The flat support side 22 of the first imprinting stamp 20 has first and second portions 26 and 28. Similarly, the second imprinting stamp 30 has a substantially flat support side 32 and an opposed imprinting side 34. The flat support side 32 of the second imprinting stamp 30 has first and second portions 36 and 38. The imprinting sides 24, 34 of the first and second stamps 20, 30 each have a non-planar surface for imprinting a three-dimensional structure. The support sides 22, 32 of the first and second stamps 20, 30 are substantially flat. By substantially flat is meant that the first and second rollers 40, 50, can roll over the support side of the imprinting sides 24, 34 without sufficiently displacing in any dimension the non-planar surface of the imprinting sides 24, 34 a distance greater than one half of any of the three-dimensional structure sizes defined by the corresponding imprinting side 24, 34. The three-dimensional structure formed by the imprinting sides 24, 34 of the first and second stamps 20, 30 can be the same in one embodiment and different in another embodiment (as shown). Methods of constructing imprinting stamps are known in the art, as are materials useful for imprinting stamps, such as PDMS. In various embodiments, the imprinting stamps are transparent, substantially transparent, or translucent, for example transmitting 50% or more of visible, infrared, or ultraviolet radiation.

The first roller 40 has a first-roller surface 42 and a first-roller axis 44 about which the first-roller surface 42 of the first roller 40 rotates or revolves as the first roller 40 is rolled over the support side 22 of the first stamp 20. Similarly, the second roller 50 has a second-roller surface 52 and a second-roller axis 54 about which the second-roller surface 52 of the second roller 50 rotates or revolves as the second roller 50 is rolled over the support side 32 of the second stamp 30.

A first curable layer 60 is formed in step 120, for example by coating or laminating curable material on the first side 12 of the substrate 10 and a second curable layer 70 on the second side 14 of the substrate 10. Curable layers and curable materials are known in the art, for example cross-linkable polymers and resins that can be cured by heat or by exposure to electromagnetic radiation such as ultraviolet radiation. In step 130, the first roller 40 is located facing the first portion 26 of the support side 22 of the first imprinting stamp 20. Likewise, the second roller 50 is located facing the first portion 36 of the support side 32 of the second imprinting stamp 30.

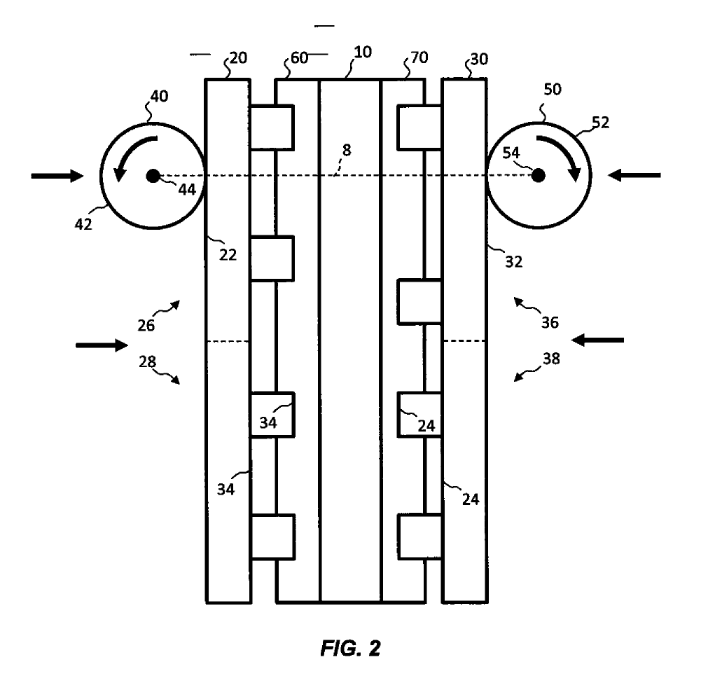

In step 140, and referring also to FIG. 2, the first roller 40 is pressed against the first portion 26 of the support side 22 of the first imprinting stamp 20. Simultaneously, the second roller 50 is pressed against the first portion 36 of the support side 32 of the second imprinting stamp 30 so that the imprinting side 24 of the first stamp 20 is at least partially in contact with the first curable layer 60 and the imprinting side 34 of the second stamp 30 is at least partially in contact with the second curable layer 70. The first-roller axis 44 of the first roller 40 is located substantially parallel to the first side 12 of the substrate 10 and the second-roller axis 54 of the second roller 50 is located substantially parallel to the second side 14 of the substrate 10 so that a perpendicular line 8 intersecting the first-roller axis 44, the second-roller axis 54, and the substrate 10 is substantially perpendicular to the first side 12 and second side 14 of the substrate 10. As illustrated in cross-sectional FIGS. 1-3, the first and second rollers 40, 50 are cylinders with first-roller and second-roller axes 44, 54 parallel to the length and first-roller and second-roller surfaces 42, 52 of the cylinder.

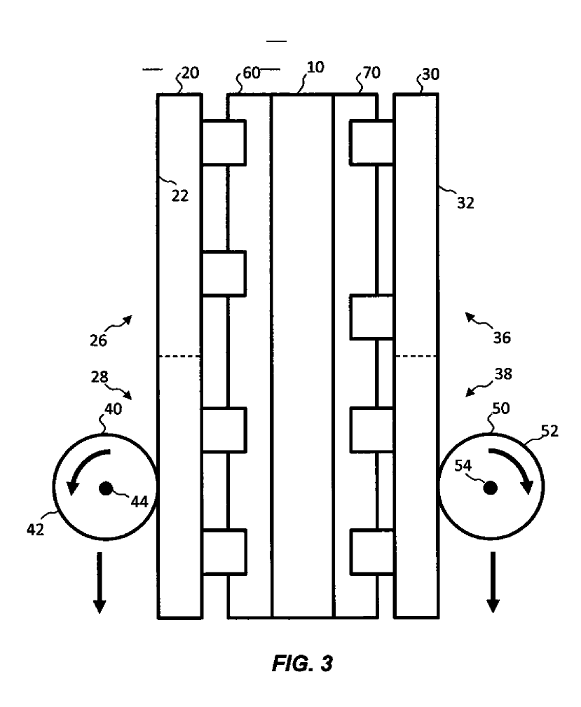

Referring also to FIG. 3, in step 150 the surface 42 of the first roller 40 is rotated about the first-roller axis 44 in contact with the support side 22 of the first imprinting stamp 20 from the first portion 26 to the second portion 28 of the first imprinting stamp 20 simultaneously with the surface 52 of the second roller 50 rotating about the second-roller axis 54 in contact with the support side 32 of the second imprinting stamp 30 from the first portion 36 to the second portion 38 of the second imprinting stamp 30. Suitable mechanisms for positioning the first and second rollers 40, 50 in relation to the first and second stamps 20, 30 and rolling the first and second rollers 40, 50 from the first portions 26, 36 to the second portions 28, 38 are known in the art and can be constructed, for example of metal.

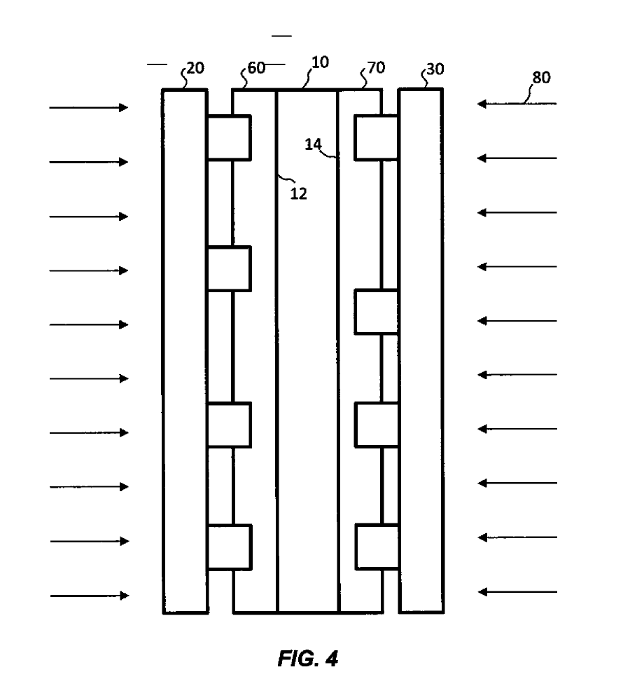

Referring to FIG. 4, in step 160 the first curable layer 60 is cured to form a first cured imprinted layer 60 on the first side 12 of the substrate 10 and, simultaneously, the second curable layer 70 is cured to form a second cured imprinted layer 70 on the second side 14 of the substrate 10. As used herein, the first curable layer 60 and first cured imprinted layer 60 are both designated as part 60, since the curable and cured layers 60 are the same layer in two different states. Similarly, the second curable layer 70 and second cured imprinted layer 70 are both designated as part 70, since the curable and cured layers 70 are the same layer in two different states. In an embodiment, both the first and second curable layer 60, 70 are simultaneously cured by exposure to heat at the same time. Alternatively, both the first and second curable layer 60, 70 are simultaneously cured by exposure to electromagnetic radiation 80, for example ultraviolet radiation at the same time. Simultaneous exposure is facilitated by exposing the first and second curable layer 60, 70 from both the first and second sides 12, 14 at the same, by employing transparent first and second stamps 20, 30, for example stamps made of PDMS, or a transparent substrate 10. In such an embodiment, radiation 80 can pass through the first and second imprinting stamps 20, 30, the first and second curable layers 60, 70, or the substrate 10 to improve exposure and curing of the first and second curable layers 60, 70. The first and second rollers 40, 50 can also be transparent or translucent so that a radiation emitter can even be located within each of the first or second rollers 40, 50, for example affixed to each of the first- and second-roller axes 44, 54. In an embodiment, a linear radiation source is provided and located parallel to the first- and second-roller axes 44, 54 to cure, or to simultaneously press and cure, the first and second curable layer 60, 70. Alternatively, or in addition, the first or second rollers 40, 50 or the first or second stamps 20, 30 are heated to facilitate curing the first and second curable layers 60, 70.

In an embodiment, the first or second roller 40, 50 is a partial cylinder having a surface arc length greater than the length of the first or second portions 26, 28, 36, 38 of the first or second stamps 20, 30, respectively. Such an arrangement can improve stability of the first or second stamps 20, 30 and rollers 40, 50, thereby improving the accuracy and resolution of the double-sided imprinted structure 5.

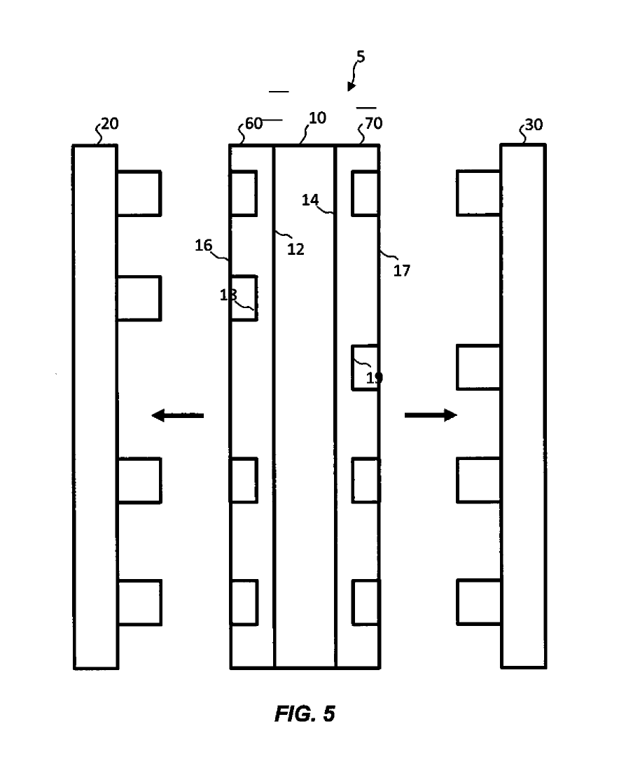

Referring to FIG. 5, in step 170 the first imprinting stamp 20 is removed from the first imprinted cured layer 60 on the first side 12 of the substrate 10 and the second imprinting stamp 30 is removed from the second imprinted cured layer 70 on the second side 14 of the substrate 10 to produce an imprinted double-sided structure 5. Removal of the first and second imprinting stamps 20, 30 is accomplished through means known in the mechanical arts.

Referring to FIGS. 1, 2, and 10, an alternative method for imprinting curable layers on parallel and opposing sides of a flexible substrate to form a double-sided imprinted structure includes:

providing a flexible substrate 10 having the first substrate side 12 and opposing second substrate sides 14 in step 101;

providing in step 110 the first imprinting stamp 20 having the rollable support side 22 and the opposing imprinting side 24, the rollable support side 22 of the first imprinting stamp 20 having the first portion 26 and the second portion 28, the imprinting side 24 of the first imprinting stamp 20 disposed opposite the first side 12 of the flexible substrate 10;

providing the second imprinting stamp 30 having the rollable support side 32 and the opposing imprinting side 34, the rollable support side 32 of the second imprinting stamp 30 having a first portion 36 and a second portion 38, the imprinting side 34 of the second imprinting stamp 30 disposed opposite a second side 14 of the flexible substrate 10 in step 220;

in step 230, disposing the first roller 40 having the surface 42 and an axis 44 about which the first roller 40 rotates adjacent to the first portion 26 of the rollable support side 22 of the first imprinting stamp 20, wherein the axis 44 of the first roller 40 is located substantially parallel to the first side 12 of the flexible substrate 10;

disposing the second roller 50 having the surface 52 and an axis 54 about which the second roller 50 rotates adjacent to the first portion 36 of the rollable support side 32 of the second imprinting stamp 30, wherein the axis 54 of the second roller 50 is located substantially parallel to the second side 14 of the flexible substrate 10, and wherein a perpendicular line 8 intersecting the axes 44, 54 of the first and second rollers 40, 50 is substantially perpendicular to the first and second substrate sides 12, 14;

in step 140, simultaneously pressing the surface 42 of the first roller 40 against the first portion 26 of the first imprinting stamp 20 and pressing the surface 52 of the second roller 50 against the first portion 36 of the second imprinting stamp 30 so that the imprinting side 24 of the first stamp 20 and the imprinting side 34 of the second stamp 30 are both at least partially in contact with the first and second curable layers 60, 70;

in step 150, simultaneously rolling the surface 42 of the first roller 40 over and in contact with the support side 22 of the first imprinting stamp 20 from the first portion 26 to the second portion 28 of the first imprinting stamp 20 and rolling the surface 52 of the second roller 50 over and in contact with the support side 32 of the second imprinting stamp 30 from the first portion 36 to the second portion 38 of the second imprinting stamp 30;

in step 160, simultaneously curing the first and second curable layers 60, 70 on the first and second sides 12, 14 of the flexible substrate 10 to form cured imprinted layers 60, 70 on the first and second sides 12, 14 of the flexible substrate 10; and

in step 170, removing the first imprinting stamp 20 from the imprinted first cured layer 60 and removing the second imprinting stamp 30 from the imprinted second cured layer 70 to form the double-sided imprinted structure 5.

In one embodiment of the present invention, the first and second curable layers 60, 70 are formed simultaneously. In various methods, the first and second curable layers 60, 70 are formed by laminating sheets on the substrate 10, by extrusion onto a surface, by curtain coating, by hopper coating, or by dip coating. These methods are known in the art.

Referring to FIGS. 2 and 3 and also to steps 140 and 150 of FIG. 9, in an embodiment, the first and second rollers 40, 50 provide equal pressure to the first and second sides 22, 32 of the first and second imprinting stamps 20, 30, respectively. Equal pressure helps to maintain stability of the substrate 10 and first and second stamps 20, 30 and thereby improve the accuracy and resolution of the imprinted double-sided structure 5 in the two curable layers 60, 70 on either side of the flexible substrate 10. In an alternative embodiment, the first and second imprinting stamps 20, 30 are pin registered together, thereby also improving the accuracy and resolution of the imprinted double-sided structure 5 in the two curable layers 60, 70.

In another embodiment, and as shown in FIG. 1, the imprinting sides 24, 34 of the first or second imprinting stamp 20, 30 includes a surface parallel to the rollable support sides 22, 32 respectively. This parallel surface need not contact the first and second curable layers 60, 70 when the first and second curable layers 60, 70 are imprinted with the first and second stamps 20, 30. In a further embodiment, the rollable support side 22, 32 of the first or second imprinting stamp 20, 30 is located parallel to the first or second sides 12, 14, respectively, of the flexible substrate 10. By providing support sides 22, 32 that are parallel to the first or second sides 12, 14, stability of the substrate 10 and the first and second stamps 20, 30 is enhanced, enabling improved accuracy and resolution of the imprinted double-sided structure 5. Likewise, in an embodiment the first and second imprinting stamps 20, 30 are the same size. Similar sizes help provide equal pressure on the first and second curable layers 60, 70, also enabling improved accuracy and resolution of the imprinted double-sided structure 5.

In an embodiment, the first and second sides of the flexible substrate are located in a vertical orientation. In a vertical orientation, the difference in the pressure exerted by the first and second stamps 20, 30 on the first and second curable layers 60, 70 is reduced. The effect of gravity on both the first and second curable layers 60, 70 is the same when the substrate is in a vertical orientation. In another embodiment, the first and second sides of the flexible substrate are located in a horizontal orientation. In a horizontal orientation, the thickness of the first and second curable layers 60, 70 is substantially the same, despite the effects of gravity.

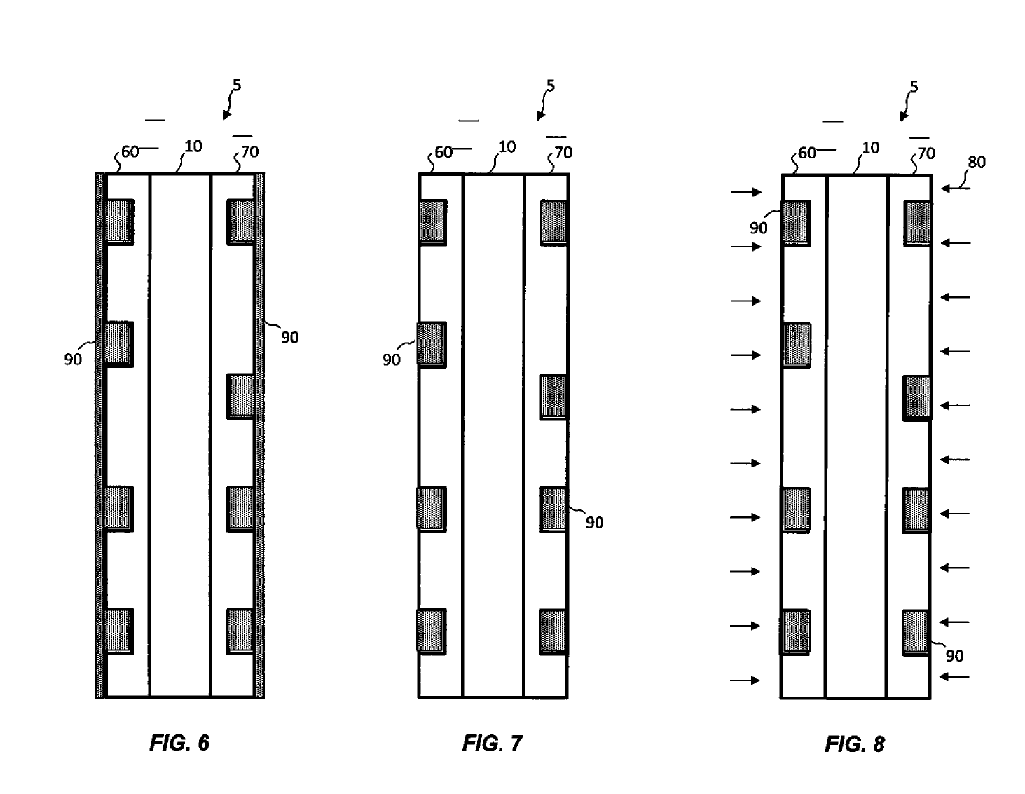

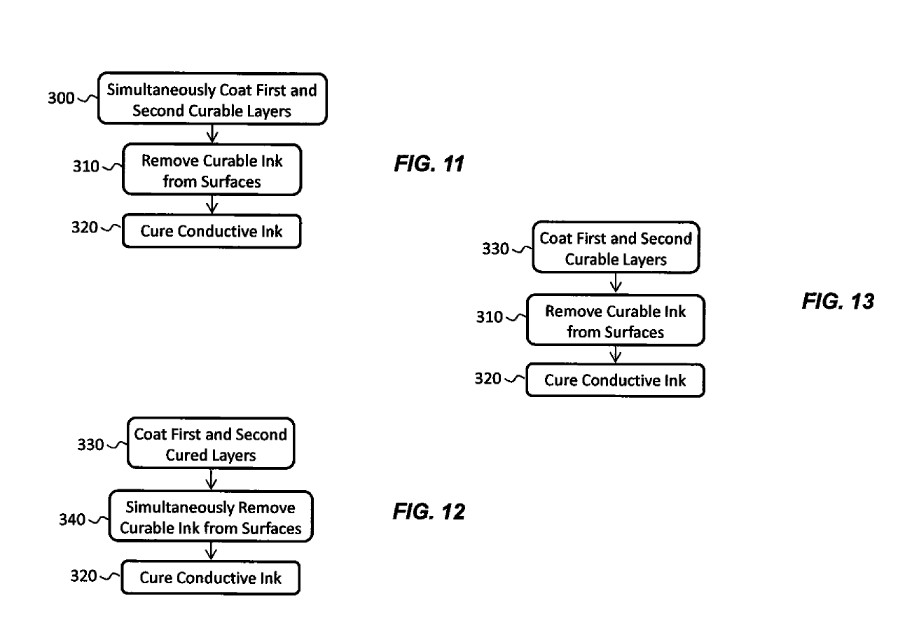

Referring to FIGS. 5, 6, 7, and 8 and FIGS. 11-13, in a further embodiment of the present invention one or both of the imprinted cured layers 60, 70 on the substrate 10 include an imprinted surface 16, 17, respectively, and imprinted micro-channels 18, 19, respectively. In this embodiment of the present invention, the imprinted surfaces 17, 18 and imprinted micro-channels 18, 19, of the first and second cured layers 60, 70 on the substrate 10 are coated with a curable conductive ink 90, either simultaneously (step 300) or at any times (step 330). The curable conductive ink is removed from the surfaces 16, 17 but not from the imprinted micro-channels 18, 19 of the imprinted first and second cured layers 60, 70 either simultaneously (step 340) or at any time (step 310) and cured in step 320, for example with radiation 80, to form a micro-wire structure in the micro-channels 18, 19. Methods of coating liquid inks, removing them from a surface, and curing them are known in the art.

The substrate 10 can be rigid or flexible made of, for example, a glass or polymer material, can be transparent, and can have opposing substantially parallel and extensive surfaces on the first and second sides 12, 14. Substrates 10 such as glass, metal, or plastic can be used and are known in the art together with methods for providing suitable surfaces. In a useful embodiment, substrate 10 is substantially transparent, for example having a transparency of greater than 90%, 80% 70% or 50% in the visible range of electromagnetic radiation. Substrates 10 can include a dielectric material useful for capacitive touch screens and can have a wide variety of thicknesses, for example 10 microns, 50 microns, 100 microns, 1 mm, or more. In various embodiments of the present invention, substrates 10 are provided as a separate structure. Substrate 10 can be an element of other devices, for example the cover or substrate of a display or a substrate, cover, or dielectric layer of a touch screen. Electrically conductive micro-wires in double-sided imprinted structures 5 of the present invention are useful, for example in touch screens such as projected-capacitive touch screens that use transparent micro-wire electrodes and in displays.

The present invention is useful in a wide variety of electronic devices. Such devices can include, for example, photovoltaic devices, OLED displays and lighting, LCD displays, plasma displays, inorganic LED displays and lighting, electrophoretic displays, electrowetting displays, dimming mirrors, smart windows, transparent radio antennae, transparent heaters and other touch screen devices such as resistive touch screen devices.

The invention has been described in detail with particular reference to certain embodiments thereof, but it will be understood that variations and modifications can be effected within the spirit and scope of the invention.

### PARTS LIST

5 imprinted double-sided structure

8 perpendicular line

10 substrate

12 first side

14 second side

16 imprinted surface of first cured layer

17 imprinted surface of second cured layer

18 imprinted micro-channel of first cured layer

19 imprinted micro-channel of second cured layer

20 first stamp

22 support side of first stamp

24 imprinting side of second stamp

26 first portion of first stamp

28 second portion of first stamp

30 second stamp

32 support side of second stamp

34 imprinting side of second stamp

36 first portion of second stamp

38 second portion of second stamp

40 first roller

42 first-roller surface

44 first-roller axis

50 second roller

52 second-roller surface

54 second-roller axis

60 first curable/cured layer

70 second curable I cured layer

80 radiation

90 curable/cured ink

100 provide substrate step

101 provide flexible substrate step

110 provide first stamp, first roller, second stamp, and second roller step

120 form first and second curable layers step

130 locate first and second stamps step

140 press first and second rollers against first and second stamps step

150 rotate first and second rollers step

160 simultaneously cure first and second curable layer step

170 remove first and second stamps step

220 dispose first and second stamps step

230 dispose first and second rollers step

300 simultaneously coat first and second layers step

310 remove curable ink step

320 cure conductive ink step

330 coat first and second layers step

340 simultaneously remove curable ink step

1. A method for making an imprinted double-sided structure, comprising:
providing a substrate having first and second substantially planar and parallel opposing sides;
providing a first imprinting stamp having a substantially flat support side and an opposed imprinting side, the support side having a first portion and a second portion;
providing a second imprinting stamp having a substantially flat support side and an opposed imprinting side, the support side having a first portion and a second portion;
providing a first roller having a surface and a first-roller axis about which the first roller surface rotates;
providing a second roller having a surface and a second-roller axis about which the second roller surface rotates;
forming a first curable layer on the first side of the substrate and a second curable layer on the second side of the substrate;
locating the imprinting side of the first imprinting stamp facing the first side of the substrate;
locating the imprinting side of the second imprinting stamp facing the second side of the substrate;
locating the first roller facing the first portion of the support side of the first imprinting stamp;
locating the second roller facing the first portion of the support side of the second imprinting stamp;
simultaneously pressing the first roller against the first portion of the first imprinting stamp and pressing the second roller against the first portion of the second imprinting stamp so that the imprinting side of the first stamp is at least partially in contact with the first curable layer and the imprinting side of the second stamp is at least partially in contact with the second curable layer, the first-roller axis located substantially parallel to the first side, the second-roller axis located substantially parallel to the second side, and a line intersecting the first-roller axis, the second-roller axis, and the substrate substantially perpendicular to the first and second sides of the substrate;
simultaneously rotating the surface of the first roller about the first-roller axis in contact with the support side of the first imprinting stamp from the first portion to the second portion of the first imprinting stamp and rotating the surface of the second roller about the second-roller axis and in contact with the second imprinting stamp from the first portion to the second portion of the second imprinting stamp;
simultaneously curing the first curable layer to form a first cured imprinted layer on the first side of the substrate and curing the second curable layer to form a second cured imprinted layer on the second side of the substrate;
removing the first imprinting stamp from the first side and removing the second imprinting stamp from the second side.

2. The method of claim 1, wherein forming a first curable layer on the first side of the substrate and a second curable layer on the second side of the substrate further includes simultaneously forming the first and second curable layers.

3. The method of claim 2, further including simultaneously forming the first and second curable layers by dip coating.

4. The method of claim 1, further including providing equal pressure with the first and second rollers to the first and second sides, respectively.

5. The method of claim 1, further including pin registering the first and second imprinting stamps together.

6. The method of claim 1, wherein the imprinting side of the first or second imprinting stamp includes a surface parallel to the rollable support side.

7. The method of claim 1, further including locating the rollable support side of the first or second imprinting stamp parallel to the flexible substrate.

8. The method of claim 1, wherein the first and second imprinting stamps are the same size.

9. The method of claim 1, further including locating the first and second sides of the flexible substrate in a vertical or horizontal orientation.

10. The method of claim 1, wherein the curable layers are cured using radiation.

11. The method of claim 10, wherein the radiation is ultra-violet radiation.

12. The method of claim 10, further including transmitting the radiation through the first or second imprinting stamp.

13. The method of claim 1, wherein the imprinted layers include a surface and imprinted micro-channels and further including forming a micro-wire structure by:
simultaneously coating the imprinted layers with a curable conductive ink;
removing the curable conductive ink from the surfaces of the imprinted layers but not the imprinted micro-channels; and
curing the curable conductive ink in the imprinted micro-channels.

14. The method of claim 1, wherein the imprinted layers include a surface and imprinted micro-channels and further including forming a micro-wire structure by:
coating the imprinted layers with a curable conductive ink;
simultaneously removing the curable conductive ink from the surfaces of the imprinted layers but not the imprinted micro-channels; and
curing the curable conductive ink in the imprinted micro-channels.

15. The method of claim 1, wherein the imprinted layers include a surface and imprinted micro-channels and further including forming a micro-wire structure by:
coating the imprinted layers with a curable conductive ink;
removing the curable conductive ink from the surfaces of the imprinted layers but not the imprinted micro-channels; and
simultaneously curing the curable conductive ink in the imprinted micro-channels.

16. The method of claim 1, further including providing a linear radiation source and moving the linear radiation source parallel to the first and second roller to simultaneously press and cure.

17. The method of claim 1, further including heating the first or second roller or the first or second stamp.

18. The method of claim 1, wherein the first or second roller is a partial cylinder having a surface arc length greater than the length of the first or second portions of the embossing stamps.

19. A method for imprinting curable layers on parallel and opposing sides of a flexible substrate to form a double-sided imprinted structure, comprising:
providing a first imprinting stamp having a rollable support side and an opposing imprinting side, the rollable support side of the first imprinting stamp having a first portion and a second portion, the imprinting side of the first imprinting stamp disposed opposite a first side of the flexible substrate;
providing a second imprinting stamp having a rollable support side and an opposing imprinting side, the rollable support side of the second imprinting stamp having a first portion and a second portion, the imprinting side of the second imprinting stamp disposed opposite a second side of the flexible substrate;
disposing a first roller having a surface and an axis about which the first roller rotates adjacent to the first portion of the rollable support side of the first imprinting stamp, wherein the axis of the first roller is located substantially parallel to the first side of the flexible substrate;
disposing a second roller having a surface and an axis about which the second roller rotates adjacent to the first portion of the rollable support side of the second imprinting stamp, wherein the axis of the second roller is located substantially parallel to the second side of the flexible substrate, and wherein a line intersecting the axes of the first and second rollers is substantially perpendicular to the substrate sides;
simultaneously pressing the first roller against the first portion of the first imprinting stamp and pressing the second roller against the first portion of the second imprinting stamp so that the imprinting side of the first stamp and the imprinting side of the second stamp are both at least partially in contact with the curable layers;
simultaneously rolling the surface of the first roller over and in contact with the support side of the first imprinting stamp from the first portion to the second portion of the first imprinting stamp and rolling the surface of the second roller over and in contact with the support side of the second imprinting stamp from the first portion to the second portion of the second imprinting stamp;
simultaneously curing the curable layers on the first and second sides of the flexible substrate to form cured imprinted layers on the first and second sides of the flexible substrate; and
removing the first imprinting stamp from the first cured imprinted layer and removing the second imprinting stamp from the second cured imprinted layer to form the double-sided imprinted structure.
